(19) United States
(12) Patent Application Publication
(10) Pub. No.: US 2002/0150090 A1
(43) Pub. Date: Oct. 17, 2002

(54) Switching system for providing an always on/dynamic ISDN service

(76) Inventor: Vi-Tus Heo, Seo-Gu (KR)

Correspondence Address: BACON & THOMAS, PLLC, 4th Floor, 625 Slaters Lane, Alexandria, VA, 22314-1176, US

(21) Appl. No.: 09/835,561

(22) Filed: Apr. 17, 2001

(51) Int. Cl. H04L 12/28

(52) U.S. Cl. 370/389; 370/474

(57) ABSTRACT

A switching system performs internally a terminal process for an AO/DI traffic directly without using a packet handler and includes a subscriber switching subsystem to thereby communicate with Internet through a router within the subscriber switching subsystem. Therefore, the switching system simplifies an ISDN call process procedure for the AO/DI service and prevents a switching resource within the switching system from being inefficiently managed to thereby provide much more subscribers with the AO/DI service.

### FIELD OF THE INVENTION

The present invention relates to a switching system; and, more particularly, to a switching system for providing an always on/dynamic ISDN (AO/DI) service through a subscriber switching subsystem without using a RAS (Remote Access Server) to thereby minimize a usage of a switching resource and simplify an ISDN call process procedure within the ISDN switching system.

### BACKGROUND OF THE INVENTION

In general, as a bi-directional communications service that uses an idle ISDN (Integrated Services Digital Network) D-channel which is not used by a subscriber of an ISDN BRI (Basic Rate Interface), AO/DI (Always On/Dynamic ISDN) service provides a various services such as E-mail (Electric mail), a news, a credit card inquiry and a various Internet services by maintaining an “always on” connection between a subscriber's terminal and a contents server via the contents server and a packet handler of a switching system.

A conventional system has the contents server as a RAS (Remote Access Server) in an outside of the switching system and provides the AO/DI service by performing communications through an ISDN PRI (Primary Rate Interface) between the contents server and the switching system.

Referring to FIG. 1, there is provided a block diagram of a conventional system providing the AO/DI service. An AO packet data path is set up as follows: at the instant AO/DI terminal 101 is turned on, a D-channel packet call set-up is automatically requested from the AO/DI terminal 101 to an ISDN switching system 110. The ISDN switching system 110 performs a D-channel packet process over a subscriber switching circuit 111, a time switch 112 and a D-channel packet handler 113, and a B-channel packet process over a space switch 114, a B-channel packet handler 115, a time switch 116, PRI 117 and an AO/DI server 120 to thereby set up an AO packet data path between the AO/DI terminal 101 and the AO/DI server 120 and transmit the packet data while maintaining “always on” state until a power of the AO/DI terminal 101 is turned off. Consequently, the subscriber receives various services of a slow speed data under 9.6 Kbps transmitted through the AO packet data path.

But, if the subscriber requests a mass file transmission of more than 9.6 Kbps through an access to the Internet, the AO/DI terminal 101 requests for a usage of the ISDN B-channel from the ISDN switching system 110 and the ISDN switching system 110 sets up a switching path for an ISDN B-channel call process over the subscriber switching circuit 111, the time switch 112 and the PRI 117, and a DI packet data path by doing a PRI switching process between the PRI 117 and the AO/DI server 120, i.e., the contents server of an RAS structure to thereby transmit the rest of the packet data which cannot be transmitted through the AO packet data path.

As mentioned above, in case that the AO/DI terminal 101 requests the data transmission only through the AO packet data path, the ISDN switching system 110 provides the services over a X.25 packet handler to thereby transmit the packet data between the AO/DI terminal 101 and the AO/DI server 120, and in case that the AO/DI terminal 101 requests the B-channel setup for a mass data transmission, the ISDN switching system 110 provides the B-channel path between the AO/DI terminal 101 and the AO/DI server 120 over a switching path regardless of the packet handler.

However, when the AO/DI service is provided from the ISDN switching system 110, in order to increase the capacity of the AO/DI service subscriber, the physical transmission line should be extended and the occupation rate of a switching resource will also increase, thereby increasing the chance that the switching resource will be managed inefficiently.

### SUMMARY OF THE INVENTION

It is, therefore, an object of the present invention to provide an always on/dynamic ISDN (AO/DI) service through a subscriber switching subsystem without using a RAS (Remote Access Server) to thereby minimize the use of a switching resource and simplify an ISDN call process procedure within the ISDN switching system.

In accordance with the present invention, there is provided a switching system for providing an AO/DI service to at least one subscriber terminal, wherein the switching system includes a subscriber switching subsystem, which includes:

a subscriber switching circuit for performing a layer 2 protocol process for providing the AO/DI service to the subscriber terminal; a device controller for reading a packet data stored in the subscriber switching circuit and adding a corresponding subscriber information to the packet data to transmit the packet data in case an AO path set-up is requested from the subscriber terminal, but also for transmitting the original packet data without adding the corresponding subscriber information in case the packet data provided is to be transmitted through a DI path established for the subscriber terminal; a server for requesting the AO path set-up for the subscriber terminal and the DI path set-up for the subscriber terminal in case the amount of data transmitted from Internet exceeds a predetermined threshold, and performing terminal processes of a layer 3 protocol and PPP for the packet data transmitted through the AO path and the DI path; a message switch module having an n×n switching structure for transmitting the packet data provided from the device controller to a corresponding server or the packet data provided from the server to a corresponding device controller through a self-routing by using the subscriber information included in the packet data; a high process for setting the DI path for a channel corresponding to an additional bandwidth when the packet data transmitted from the subscriber switching circuit or the server includes a request for setting up the DI path; and a router for transceiving the packet data between the server and the Internet by using an IP address included in the packet data.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of a conventional system providing the AO/DI service; and

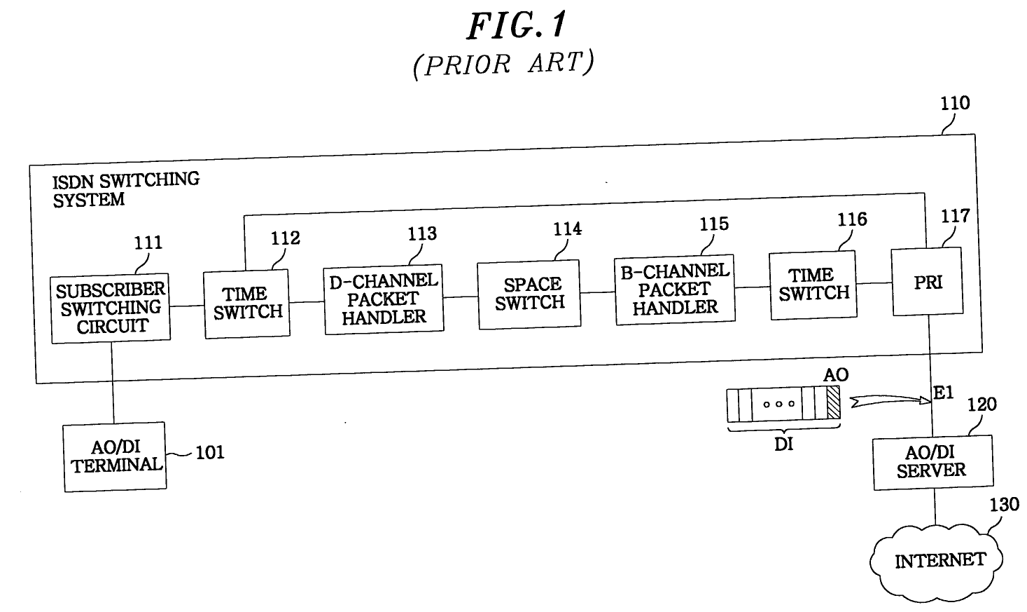

FIG. 2 presents a block diagram of a system providing the AO/DI service by using an ISDN switching system in accordance with the present invention.

### DETAILED DESCRIPTION OF THE PREFERRED EMBODIMENTS

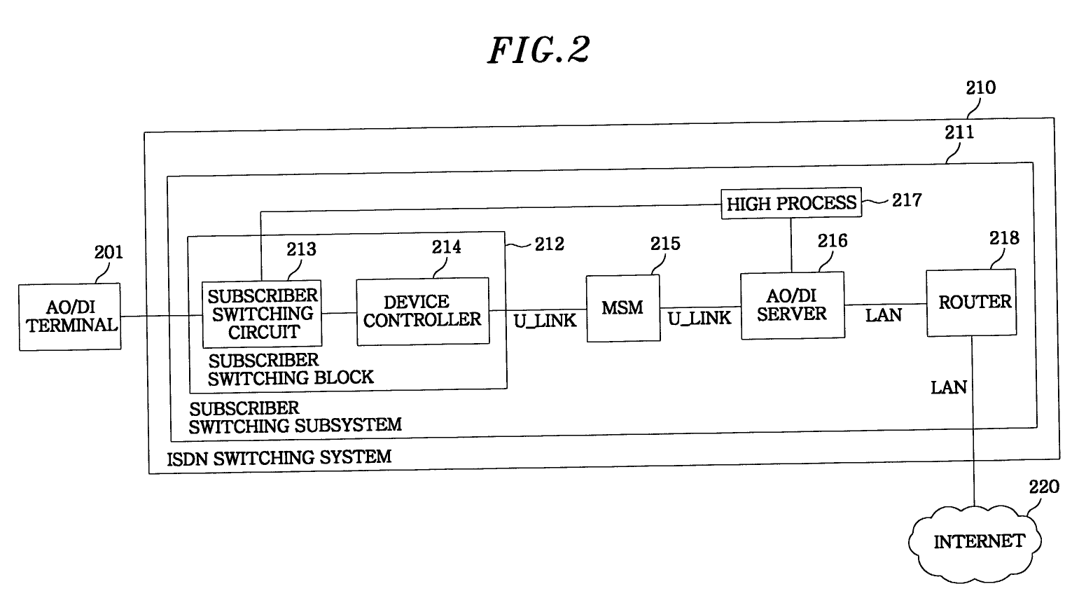

Referring to FIG. 2, there is provided a block diagram of a system providing the AO/DI service by using an ISDN switching system in accordance with the present invention. The system comprises an AO/DI terminal 201, an ISDN switching system 210 and Internet 220, wherein the ISDN switching system 210 includes a subscriber switching subsystem 211 that is improved in accordance with the present invention.

The subscriber switching subsystem 211 includes a subscriber switching block 212 for performing a switching process between the AO/DI terminal 201 and the ISDN switching system 210 by processing a layer two protocol for data transceiving with the AO/DI terminal 201, an MSM (Message Switch Module) 215 connected to the subscriber switching block 212 through a U_link, an AO/DI server 216 connected to the MSM 215 through the U_link, a high process 217 for the AO/DI server 216 and the subscriber switching block 212, and a router 218 connecting the AO/DI server 216 to the Internet 220 in order to communicate in an environment such as a LAN (Local Area Network). The U_link has a structure synchronized with a clock signal of 8 MHz for transmitting data.

In the system, when a power of the arbitrary AO/DI terminal 201 is supplied, the corresponding AO/DI terminal 201 requests for the D-channel packet call automatically.

A subscriber switching circuit 213 within the subscriber switching block 212 processes the layer two protocol for the packet data transmitted through the D-channel from the AO/DI terminal 201 and then stores the processed packet data in a common memory (not shown) equipped within the subscriber switching circuit 213. A device controller 214 reads the packet data stored in the common memory and then adds subscriber information on the corresponding packet data to a header region. The added subscriber information is information such as an SAI (Service Access Identifier), a TEI (Terminal End Identifier), a subscriber line number and etc. The packet data is transmitted to the MSM 215 through the U_link.

The MSM 215, which performs a self-routing on a byte basis for a transmitted message and has an n×n switching structure, transmits a message transmitted from the device controller 214 to the corresponding AO/DI server 216 and operates to transmit a message transmitted from the AO/DI server 216 to the corresponding subscriber switching block 212 by using the subscriber information in the header region of the message. Herein, the MSM 215 transmits the packet message transmitted from the subscriber switching block 212 to the AO/DI server 216 by multiplexing the packet message and transmits the packet message transmitted from the AO/DI server 216 to the subscriber switching block 212 by demultiplexing the packet message. The subscriber switching block 212 and the AO/DI server 216 included in the switching subsystem 211 play essential roles in the processes, respectively.

The AO/DI server 216 analyzes the header information of the packet data received from the MSM 215 and provides an intrinsic call number. A method providing the intrinsic call number can be implemented in correlation with the total number of the subscribers provided with the AO/DI service by providing a number obtained by adding 1 to the number of the currently maintained D-channels. Herein, the provided call number is maintained when the call is released from the corresponding subscriber and the call release occurs until the AO/DI terminal is turned off.

Next, the AO/DI server 216 performs a protocol terminal process for a layer 3, analyzes a call request packet and then requests the high process 217 for a confirmation whether the corresponding subscriber is a legitimate subscriber for receiving the service. As a result of the confirmation request, if the subscriber is confirmed as a legitimate subscriber for receiving the service, the AO/DI server 216 transmits a setup completion packet of a call connection to the AO/DI terminal 201. The setup completion packet is transmitted to the AO/DI terminal 201 through a path connecting the MSM 215 with the device controller 214 and the common memory (not shown) in the subscriber switching circuit 213 within the corresponding subscriber switching block 212. Accordingly, the transmission path for a basic data is set up between the AO/DI terminal 201 and the AO/DI server 216.

By using the data transmission path, the AO/DI terminal 201 and the AO/DI server 216 perform a PPP (Point-to-Point Protocol) link setting, user authentication and IP (Internet Protocol) layer setting, connect each layer to perform a mutual PPP terminal process and assign an IP address to thereby make the Internet communications possible. The IP address is a 32-bit address defined in the Internet protocol.

Subsequently, the AO/DI server 216 maps the assigned IP address to the call number to store the assigned IP address. That is to transmit the message between the router 218 and the MSM 215 through the corresponding path. And, the AO/DI server 216 transmits the PPP terminal processed packet data including the IP address to the router 218.

For the ISDN switching system 210 to provide the corresponding AO/DI terminal 201 with a corresponding service from the Internet 220 connected to the LAN environment, the router 218 performs a routing by using the IP address included in the received packet data to transmit the packet data to the Internet 220 and a routing by using the IP address included in a data transmitted from the Internet 220 to transmit the data to the corresponding AO/DI server 216.

As mentioned above, in a data transmission through the AO transmission path, in case the AO/DI terminal 201 or the AO/DI server 216 requests for a transmission of data whose amount exceeds a predetermined threshold, i.e., over 9.6 Kbps, an ISDN B-channel is added through the general ISDN call set-up procedure.

Namely, if the AO/DI terminal 201 transmits the data whose amount secedes the predetermined threshold, the AO/DI terminal 201 requests for the ISDN call set-up to the ISDN switching system 210 through the D-channel. Herein, the call set-up request signal including information on the number of B-channels additionally needed is transmitted to the subscriber switching circuit 213 and the subscriber switching circuit 213 reports the call set-up request signal to the high process 217. When the analysis of the call setup request signal indicates a request for an additional bandwidth assignment, the high process 217 allows the subscriber switching circuit 213 to assign number of B-channels corresponding to the requested bandwidth to the DI path of the corresponding AO/DI terminal 201.

Therefore, the subscriber switching circuit 213 treats the data transmitted from the AO/DI terminal 201 through the B-channels allowed by the high process 217 as the data for communicating with the Internet 220 and transmits the data to the device controller 214. Then, the device controller 214 does not add the subscriber information to the data provided through the DI path and transmits the original data to the MSM 215. The remaining transmission process of the data is identical to that of the data through the AO path.

Meanwhile, in case of transmitting data the amount of which exceeds the predetermined threshold, the AO/DI server 216 requests for an additional bandwidth to the high process 217 and if a usage of a corresponding DI path is permitted by the high process 217, the AO/DI server 216 transmits the remaining data which are not transmitted through the D-channel to the MSM 215 through the B-channel. The data transmitted to the MSM 215 is transmitted in a same way as the data transmitted to the AO/DI terminal 201 through the AO path.

While the invention has been shown and described with respect to the preferred embodiments, it will be understood by those skilled in the art that various changes and modifications may be made without departing from the spirit and scope of the invention as defined in the following claims.

What is claimed is:

1. A switching system connected to Internet for providing an AO/DI service to at least one subscriber terminal, wherein the switching system includes a subscriber switching subsystem, which comprises:
a subscriber switching circuit for performing a layer 2 protocol process for providing the AO/DI service to the subscriber terminal;
a device controller for reading a packet data stored in the subscriber switching circuit and adding a corresponding subscriber information to the packet data to transmit the packet data in case an AO path set-up is requested from the subscriber terminal, but also for transmitting the original packet data without adding the corresponding subscriber information in case the packet data provided is to be transmitted through a DI path established for the subscriber terminal;
a server for requesting the AO path set-up for the subscriber terminal and the DI path set-up for the subscriber terminal in case an amount of data transmitted from Internet exceeds a predetermined threshold, and performing terminal processes of a layer 3 protocol and PPP for the packet data transmitted through the AO path and the DI path;
a message switch module having an n×n switching structure for transmitting the packet data provided from the device controller to a corresponding server or the packet data provided from the server to a corresponding device controller through a self-routing by using the subscriber information included in the packed data;
a high process for setting the DI path for a channel corresponding to an additional bandwidth when the packet data transmitted from the subscriber switching circuit or the server includes a request for setting up the DI path; and
a router for transceiving the packet data between the server and the Internet by using an IP address included in the packet data.

2. The switching system of claim 1, wherein when the AO path is set, the server transmits the packet data to be transmitted between the message switch module and the router through the corresponding AO path by setting an intrinsic call number for the subscriber terminal and storing the intrinsic call number mapped to the IP address assigned by a corresponding PPP terminal process.

3. The switching system of claim 1, wherein in case the AO path set-up is requested as a result of the analysis of the packet data transmitted from the message switch module, the server inquires of the high process whether the subscriber terminal is a legitimate receiver for the AO/DI service or not.
